(19) United States
(12) Patent Application Publication
(10) Pub. No.: US 2025/0182375 A1
(43) Pub. Date: Jun. 5, 2025

(54) DISPLAY CONTROL METHOD AND APPARATUS, AUGMENTED REALITY HEAD-MOUNTED DEVICE, AND MEDIUM

(71) Applicant: GOERTEK INC., Weifang, Shandong (CN)

(72) Inventor: Yufeng LI, Weifang, Shandong (CN)

(21) Appl. No.: 18/845,015

(22) PCT Filed: Aug. 8, 2023
(86) PCT No.: PCT/CN2023/111761

§ 371 Date: Sep. 9, 2024

(30) Foreign Application Priority Data
Sep. 29, 2022 (CN) 202211204523.9

(51) Int. Cl. G06T 15/04; G06F 9/451; G06T 15/06

(52) U.S. Cl. CPC G06T 15/04; G06F 9/452; G06T 15/06; G06T 2200/24; G06T 2210/21

(57) ABSTRACT

A display control method, display control apparatus, an augmented reality head-mounted device, and a medium. The display control method includes: receiving, in a running process of a 3D desktop environment, a first enable instruction for enabling a first application; creating a first canvas and a first virtual screen in the 3D desktop environment in response to the first enable instruction when the first application is a 2D application; running the first application on the first virtual screen; and acquiring texture information from the first virtual screen, and rendering the texture information acquired from the first virtual screen onto the first canvas.

The present disclosure claims the priority to the Chinese Patent Application No. 202211204523.9, entitled “DISPLAY CONTROL METHOD AND APPARATUS, AUGMENTED REALITY HEAD-MOUNTED DEVICE, AND MEDIUM” filed with China Patent Office on Sep. 29, 2022, the entire contents of which are incorporated into the present disclosure by reference.

### TECHNICAL FIELD

The present disclosure relates to a technical field of wearable devices, and more specifically, to a display control method and apparatus, an augmented reality head-mounted device, and a medium.

### DESCRIPTION OF RELATED ART

With the continuous development of augmented reality technology, many AR products and AR applications have emerged. In augmented reality head-mounted devices, users have a need to use traditional applications: in a 3D desktop environment. However, since the traditional applications are generally in 2D, they cannot be displayed and interacted normally in 3D scenes. Therefore, it is necessary to provide a solution for running 2D applications in a 3D desktop environment.

### SUMMARY

An object of the present disclosure is to provide a solution for running 2D applications in a 3D desktop environment.

According to a first aspect of the embodiment of the present disclosure, a display control method for an augmented reality head-mounted device is provided, the method including:
receiving a first enable instruction for enabling a first application in a running process of a 3D desktop environment;
creating a first canvas and a first virtual screen in the 3D desktop environment in response to the first enable instruction when the first application is a 2D application;
running the first application on the first virtual screen; and
acquiring texture information from the first virtual screen, and rendering the texture information acquired from the first virtual screen onto the first canvas.

Optionally, the method further includes:
detecting whether a 3D engine tag is contained in a global configuration file of the first application when the first enable instruction is received; if not, determining the first application as a 2D application.

Optionally, the method further includes:
acquiring attribute information of the first application from an application menu provided by the 3D desktop operating environment when the first enable instruction is received, and determining whether the first application is a 2D application according to the attribute information of the first application.

Optionally, the method further includes:
exiting the 3D desktop environment in response to the first enable instruction when the first application is a 3D application, and starting the first application after the 3D desktop environment is exited.

Optionally, the method further includes: after starting the first application,
receiving a first control instruction to exit the first application;
exiting the first application in response to the first control instruction, and running the 3D desktop environment.

Optionally, the method further includes:
receiving an operation instruction from a user in a process of running the first application;
acquiring a coordinate value of a collision point in the first canvas when a 3D ray mapped by the operation instruction collides with the first canvas;
determining a target pixel on the first virtual screen corresponding to the collision point according to the coordinate value of the collision point in the first canvas; and
controlling the first application to trigger a touch event corresponding to the target pixel.

Optionally, the method further includes:
receiving a second enable instruction for enabling a second application in the running process of the 3D desktop environment;
creating a second canvas and a second virtual screen in the 3D desktop environment in response to the second enable instruction when the second application is a 2D application, wherein the first canvas and the second canvas are located at different positions in the 3D desktop environment;
running the second application on the second virtual screen; and
acquiring texture information from the second virtual screen, and rendering the texture information acquired from the second virtual screen onto the second canvas.

According to a second aspect of the embodiment of the present disclosure, display control apparatus for an augmented reality head-mounted device is provided, the apparatus including:
a receiving module configured to receive a first enable instruction for enabling a first application in a running process of a 3D desktop environment;
a creation module configured to create a first canvas and a first virtual screen in the 3D desktop environment in response to the first enable instruction when the first application is a 2D application;
a running module configured to run the first application on the first virtual screen; and
a rendering module configured to acquire texture information from the first virtual screen and render the texture information acquired from the first virtual screen onto the first canvas.

According to a third aspect of the embodiment of the present disclosure, an augmented reality head-mounted device is provided, the device including:
a memory configured to executable computer instructions; and
a processor configured to execute the display control method according to the first aspect under the control of the executable computer instructions.

According to a fourth aspect of the present disclosure, a computer-readable storage medium is provided, on which computer instructions are stored, wherein the computer instructions, when executed by a processor, executes the display control method according to the first aspect.

A beneficial effect of the embodiment of the present disclosure is that: in a 3D desktop environment of an augmented reality head-mounted device, upon receiving an enable instruction from a user to start a 2D application, a canvas and a virtual screen corresponding to the 2D application are created in the 3D desktop environment, the 2D application is started and runs on the virtual screen, and texture information is acquired from the virtual screen and rendered onto the canvas, so that the 2D application can be displayed in the 3D desktop environment.

Other features and advantages of the present specification will become apparent from the following detailed description of exemplary embodiments of the present specification with reference to the accompanying drawings.

### BRIEF DESCRIPTION OF DRAWINGS

The accompanying drawings, which are incorporated in and constitute a part of the specification, illustrate embodiments of the specification and, together with the description, serve to explain the principles of the specification.

FIG. 1 is a schematic diagram of hardware configuration of smart glasses according to an embodiment of the present disclosure;

FIG. 2 is a schematic diagram of a scene according to an embodiment of the present disclosure;

FIG. 3 is a flow chart of a display control method according to an embodiment of the present disclosure;

FIG. 4 is a flow chart of a display control method according to another embodiment of the present disclosure;

FIG. 5 is a principle block diagram of display control apparatus according to an embodiment of the present disclosure; and

FIG. 6 is a principle block diagram of smart glasses according to an embodiment of the present disclosure.

### DETAILED DESCRIPTIONS

Various exemplary embodiments of the present disclosure will now be described in detail with reference to the accompanying drawings. It should be noted that relative arrangements of components and steps, numerical expressions and numerical values set forth in these embodiments do not limit the scope of the embodiments of the present disclosure unless specifically stated otherwise.

The following description of at least one exemplary embodiment is merely illustrative in nature and is in no way intended to limit the present disclosure, its applications, or uses.

The technologies, methods and devices known to those skilled in the art may not be discussed in detail, but where appropriate, the technologies, methods and devices should be considered as part of the specification.

In all examples shown and discussed herein, any specific values should be interpreted as merely exemplary and not as limiting. Therefore, other examples of the exemplary embodiments may have different values.

It should be noted that like reference numerals and letters refer to similar items in the accompanying drawings, and therefore, once an item is defined in one figure, it may not be further discussed in subsequent figure(s).

### Hardware Configuration

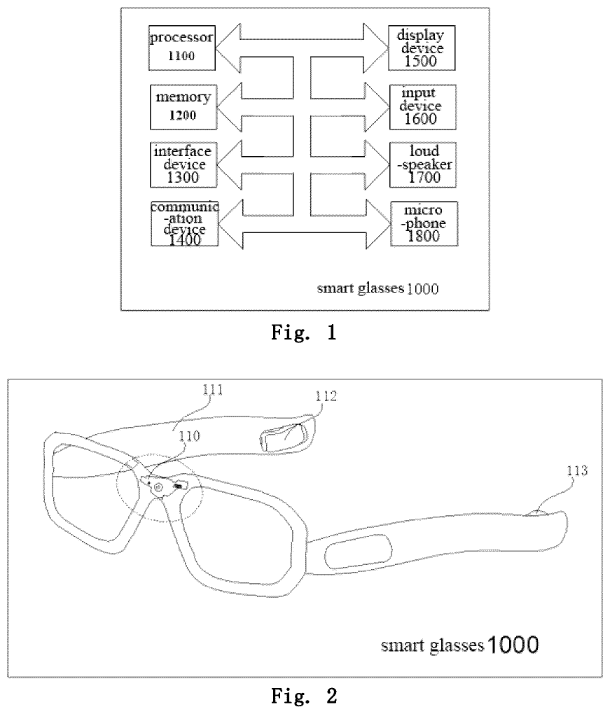

FIG. 1 is a block diagram of hardware configuration of smart glasses 1000 according to an embodiment of the present disclosure.

In an embodiment, as illustrated in FIG. 1, the smart glasses 1000 may include a processor 1100, a memory 1200, an interface device 1300, a communication device 1400, a display device 1500, an input device 1600, a loudspeaker 1700, a microphone 1800, etc.

The processor 1100 may include, but is not limited to, a central processing unit (CPU), a micro processing unit (MCU), and the like. The memory 1200 includes, for example, a read only memory (ROM), a random access memory ((RAM), a non-volatile memory such as a hard disk, and the like. The interface device 1300 includes, for example, various bus interfaces, such as a serial bus interface (including a USB interface), a parallel bus interface, etc. The communication device 1400 is capable of, for example, wired or wireless communication. The display device 1500 is, for example, a liquid crystal display, a LED display, an organic light emitting diode (OLED) display, or the like. The input device 1600 includes, for example, a touch screen, a keyboard, a handle, and the like. The smart glasses 1000 can output audio information through the loudspeaker 1700 and collect audio information through the microphone 1800.

Those skilled in the art should understand that, although various devices of the smart glasses 1000 are shown in FIG. 1, the smart glasses 1000 of embodiments of the specification may only involve some of the devices therein, or may also include other devices, which is not limited herein.

In the embodiment, the memory 1200 of the smart glasses 1000 is used to store instructions, which are used to control the processor 1100 to operate to implement or support the implementation of the display control method according to any embodiment. Those skilled in the art can design instructions according to the solutions disclosed in this specification. How instructions control the operation of the processor is well known in the art and will not be described in detail herein.

In the above description, those skilled in the art can design instructions according to the solutions provided by the present disclosure. How instructions control the operation of the processor is well known in the art and will not be described in detail herein.

In another embodiment, as illustrated in FIG. 2, the smart glasses 1000 include a display component 110, a frame 111, and two antennas, wherein one antenna 112 of the two antennas is disposed at a first end of the frame 111, and the other antenna 113 is disposed at a second end of the frame 111. The antenna 112 and the antenna 113 are used to receive a first signal transmitted by a target object 2000. Exemplarily, the antenna 112 and the antenna 113 may both be Bluetooth antennas. The target object 2000 can transmit Bluetooth signals, and the antenna 112 and the antenna 113 are used to receive the Bluetooth signals transmitted by the target object 2000. Of course, the two antennas may also be antennas of other types, which is not limited in the embodiment. The smart glasses 1000 may further include a camera device (not shown in the drawings).

The smart glasses shown in FIG. 1 are illustrative only and are in no way intended to limit the present disclosure, its applications, or uses.

### Method Embodiment

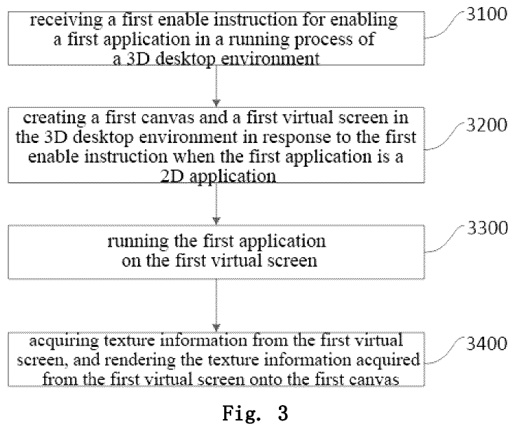

FIG. 3 illustrates a display control method according to an embodiment of the present disclosure, which is applied to an augmented reality head-mounted device. The display control method can be implemented by the head-mounted display device, or can be implemented jointly by a control device independent of the head-mounted display device and the head-mounted display device, or can be implemented jointly by a cloud server and the head-mounted display device. The augmented reality head-mounted device may be, for example, the smart glasses 1000 as illustrated in FIG. 1, which include a display component, a frame, and two antennas, wherein one of the two antennas is disposed at a first end of the frame, and the other is disposed at a second end of the frame.

As illustrated in FIG. 3, the display control method of the embodiment may include the following steps S3100 to S3400.

At S3100, in a running process of a 3D desktop environment, a first enable instruction for enabling a first application is received.

In smart glasses, ARlauncher is a 3D desktop launcher, when the device is turned on, ARlauncher starts and the 3D desktop environment begins running. After the user wears the smart glasses, the 3D desktop environment is displayed within the user's field of vision, and the user starts the first application in the 3D desktop environment by inputting a first enable instruction.

At S3200, when the first application is a 2D application, a first canvas and a first virtual screen are created in the 3D desktop environment in response to the first enable instruction.

In an embodiment, when the first enable instruction is received, whether a global configuration file of the first application contains a 3D engine tag is detected, and if not, it is determined that the first application is a 2D application.

The 3D engine is Unity or Unreal. In a 3D application developed using the Unity or Unreal engine, a 3D engine tag of “unity” or “unreal” is provided in the tag of AndroidManifest. It is detected whether the global configuration file of the first application contains a 3D engine tag. If yes, it is determined that the first application is a 3D application; if no, it is determined that the first application is a 2D application.

In an embodiment, when the first enable instruction is received, attribute information of the first application is acquired from an application menu provided by the 3D desktop operating environment, and whether the first application is a 2D application is determined according to the attribute information of the first application.

Since the Unity or Unreal engine may also be used to develop 2D applications, there may be deviations if the type of the first application is determined only by the 3D engine label. Therefore, the user can acquire the attribute information of the first application that is preset manually in the application menu provided by ARlauncher, and determine whether the first application is a 2D application based on the attribute information. When it is determined that the first application is a 2D application, the first application is run on the first virtual screen.

In an embodiment, when the first application is a 2D application, a first virtual screen is created in an ARlauncher interface and the first virtual screen is marked with a number, and the first virtual screen, the canvas, and the first application are bound. The first virtual screen and the name of a corresponding apk file of the first application are transmitted to an aar package. Here, the aar package is used to store code and is a connection tool between the Unity and the virtual screen. The aar package is equivalent to a software development kit SDK, in which a plurality of API interfaces can be called. The Untiy engine creates a first virtual screen through the aar package and starts the first application, and the Untiy engine creates a first canvas.

In an embodiment, it is detected whether the global configuration file of the first application contains a 3D engine tag. If yes, it is determined that the first application is a 3D application. When the first application is a 3D application, the 3D desktop environment is exited in response to the first enable instruction; and after exiting the 3D desktop environment, the first application is started.

In the embodiment, when it is determined that the first application is a 3D application, the method further includes: after starting the first application,
receiving a first control instruction to exit the first application;
exiting the first application in response to the first control instruction, and re-running the 3D desktop environment.

At S3300, the first application is run on the first virtual screen.

In an embodiment, after the aar package receives the first enable instruction, the first virtual screen corresponding to the aar package is activated, and the corresponding first application is opened in the first virtual screen according to the name information of the apk file transmitted by ARlauncher.

At S3400, texture information is acquired from the first virtual screen, and the texture information acquired from the first virtual screen is rendered onto the first canvas.

In an embodiment, display information of the first virtual screen is captured and rendered into the first canvas, and the first canvas is used to display the rendered content to a user wearing an augmented reality head-mounted device.

In an embodiment of the present disclosure, the display control method for an augmented reality head-mounted device further includes:
receiving an operation instruction from the user in the process of running the first application, wherein the operation instruction is a handle manipulation instruction, a gesture manipulation instruction, or a sight manipulation instruction;
acquiring a coordinate value of a collision point in the first canvas when a 3D ray mapped by the operation instruction collides with the first canvas;
determining a target pixel on the first virtual screen corresponding to the collision point according to the coordinate value of the collision point in the first canvas; and
controlling the first application to trigger a touch event corresponding to the target pixel.

In the embodiment, when a 3D ray mapped by the operation instruction of the user collides with the canvas, a corresponding touch event can be triggered for the 2D application, thereby realizing interaction between the 2D application running in the 3D desktop environment and the user.

In an embodiment of the present disclosure, the display control method for an augmented reality head-mounted device further includes:
receiving a second enable instruction for enabling a second application in the running process of the 3D desktop environment;
creating a second canvas and a second virtual screen in the 3D desktop environment in response to the second enable instruction when the second application is a 2D application, wherein the first canvas and the second canvas are located at different positions in the 3D desktop environment;
running the second application on the second virtual screen; and
acquiring texture information from the second virtual screen, and rendering the texture information acquired from the second virtual screen onto the second canvas.

In the embodiment, creating multiple canvases at different locations in the 3D desktop environment allows multiple 2D applications to be run simultaneously in the 3D desktop environment, and it does not require a long preparation time when multiple 2D applications are switched. The embodiment can run multiple 2D applications in the 3D desktop environment, thereby improving the versatility of user interaction.

According to the embodiment of the present disclosure, in a 3D desktop environment of an augmented reality head-mounted device, when an enable instruction from a user to enable a 2D application is received, a canvas and a virtual screen corresponding to the 2D application are created in the 3D desktop environment, the 2D application is started and run on the virtual screen, and texture information is acquired from the virtual screen and rendered onto the canvas, so that the 2D application can be displayed in the 3D desktop environment.

### Example

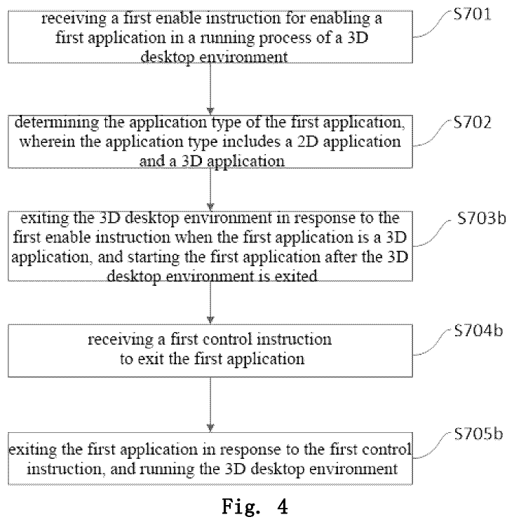

Hereinafter, taking the head-mounted display device as smart glasses as an example, an example display control method is illustrated. Referring to FIG. 4, the display control method may include the following steps:
Step S701: receiving a first enable instruction for enabling a first application in a running process of a 3D desktop environment;
Step S702: determining the application type of the first application, wherein the application type includes a 2D application and a 3D application;
Step S703a: creating a first canvas and a first virtual screen in the 3D desktop environment in response to the first enable instruction when the first application is a 2D application;
Step S704a: running the first application on the first virtual screen;
Step S705a: acquiring texture information from the first virtual screen, and rendering the texture information acquired from the first virtual screen onto the first canvas;
Step S706: receiving an operation instruction from a user in a process of running the first application;
Step S707: acquiring a coordinate value of a collision point in the first canvas when a 3D ray mapped by the operation instruction collides with the first canvas;
Step S708: determining a target pixel on the first virtual screen corresponding to the collision point according to the coordinate value of the collision point in the first canvas;
Step S709: controlling the first application to trigger a touch event corresponding to the target pixel;
Step S7010: receiving a second enable instruction for enabling a second application in the running process of the 3D desktop environment;
Step S7011: creating a second canvas and a second virtual screen in the 3D desktop environment in response to the second enable instruction when the second application is a 2D application, wherein the first canvas and the second canvas are located at different positions in the 3D desktop environment;
Step S7012: running the second application on the second virtual screen; and
Step S7013: acquiring texture information from the second virtual screen, and rendering the texture information acquired from the second virtual screen onto the second canvas.

Referring to FIG. 4, the display control method may also include the following steps:
Step S701: receiving a first enable instruction for enabling a first application in a running process of a 3D desktop environment;
Step S702: determining the application type of the first application, wherein the application type includes a 2D application and a 3D application;
Step S703b: exiting the 3D desktop environment in response to the first enable instruction when the first application is a 3D application, and starting the first application after the 3D desktop environment is exited;
Step S704b: receiving a first control instruction to exit the first application;
Step S705b: exiting the first application in response to the first control instruction, and running the 3D desktop environment.

### Apparatus Embodiment

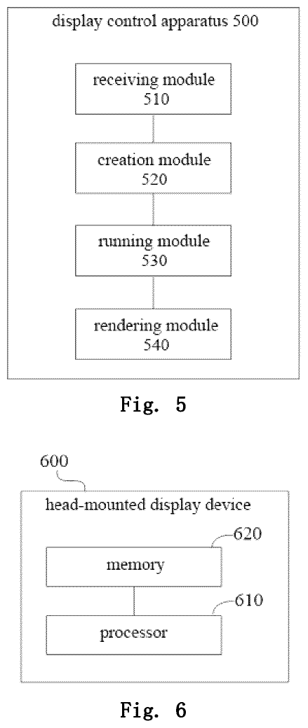

FIG. 5 is a schematic structural diagram of display control apparatus for an augmented reality head-mounted device according to an embodiment. The display control apparatus is applied to smart glasses, which include a display component, a frame and two antennas, wherein one of the two antennas is disposed at a first end of the frame, and the other is disposed at a second end of the frame. As illustrated in FIG. 5, the display control apparatus 500 includes a receiving module 510, a creation module 520, a running module 530, and a rendering module 540.

The receiving module 510 is configured to receive a first enable instruction for enabling a first application in a running process of a 3D desktop environment.

The creation module 520 is configured to create a first canvas and a first virtual screen in the 3D desktop environment in response to the first enable instruction when the first application is a 2D application.

The running module 530 is configured to run the first application on the first virtual screen.

The rendering module 540 is configured to acquire texture information from the first virtual screen and render the texture information acquired from the first virtual screen onto the first canvas.

In an embodiment, the apparatus 500 further includes a first determination module (not shown in the drawings).

The first determination module is configured to detect whether the global configuration file of the first application contains a 3D engine tag when the first enable instruction is received, and if not, determine that the first application is a 2D application.

In an embodiment, the apparatus 500 further includes a second determination module (not shown in the drawings).

The second determination module is configured to acquire attribute information of the first application from an application menu provided by the 3D desktop operating environment when the first enable instruction is received, and determine whether the first application is a 2D application according to the attribute information of the first application.

In an embodiment, the apparatus 500 further includes an exit module and an enable module (not shown in the drawings).

The exit module is configured to exit the 3D desktop environment in response to the first enable instruction when the first application is a 3D application.

The enable module is configured to enable the first application after exiting the 3D desktop environment.

In an embodiment, the apparatus 500 further includes a second receiving module and a second running module (not shown in the drawings).

The second receiving module is configured to receive a first control instruction to exit the first application.

The second running module is configured to exit the first application in response to the first control instruction and run the 3D desktop environment.

In an embodiment, the apparatus 500 further includes a third receiving module, an acquisition module, a third determination module and a control module (not shown in the drawings).

The third receiving module is configured to receive an operation instruction of the user in the process of running the first application.

The acquisition module is configured to acquire a coordinate value of a collision point in the first canvas when a 3D ray mapped by the operation instruction collides with the first canvas.

The third determination module is configured to determine a target pixel on the first virtual screen corresponding to the collision point according to the coordinate value of the collision point in the first canvas.

The control module is configured to control the first application to trigger a touch event corresponding to the target pixel.

In an embodiment, the apparatus 500 further includes a fourth receiving module, a second creation module, a third running module and a second rendering module (not shown in the drawings).

The fourth receiving module is configured to receive a second enable instruction for enabling a second application in the running process of a 3D desktop environment.

The second creation module is configured to create a second canvas and a second virtual screen in the 3D desktop environment in response to the second enable instruction when the second application is a 2D application, wherein the first canvas and the second canvas are located at different positions in the 3D desktop environment.

The third running module is configured to run the second application on the second virtual screen.

The second rendering module is configured to acquire texture information from the second virtual screen and render the texture information acquired from the second virtual screen onto the second canvas.

According to the embodiment of the present disclosure, in a 3D desktop environment of an augmented reality head-mounted device, upon receiving an enable instruction from a user to start a 2D application, a canvas and a virtual screen corresponding to the 2D application are created in the 3D desktop environment, the 2D application is started and run on the virtual screen, and texture information is acquired from the virtual screen and rendered onto the canvas, so that the 2D application can be displayed in the 3D desktop environment.

### Device Embodiment

FIG. 6 is a schematic diagram of hardware structure of a head-mounted display device according to an embodiment. As illustrated in FIG. 6, the head-mounted display device 600 includes a processor 610 and a memory 620.

The memory 620 may be used to store executable computer instructions.

The processor 610 may be used to execute the display control method according to the method embodiment under the control of the executable computer instructions.

The head-mounted display device 600 may be the head-mounted display device 1000 as illustrated in FIG. 1, or may be a device having other hardware structures, which is not limited herein.

In another embodiment, the head-mounted display device 600 may include the above display control apparatus 500.

In an embodiment, each module of the above display control apparatus 500 can be implemented by the processor 610 running computer instructions stored in the memory 620.

### Computer-Readable Storage Medium

An embodiment of the present disclosure also provides a computer-readable storage medium, on which computer instructions are stored, wherein the computer instructions, when executed by a processor, executes the display control method provided by the embodiment of the present disclosure.

The present disclosure may be a system, method, and/or computer program product. The computer program product may include a computer-readable storage medium carrying computer-readable program instructions for causing a processor to implement various aspects of the present disclosure.

The computer-readable storage medium may be tangible devices that can hold and store instructions for use by instruction execution devices. For example, the computer-readable storage medium may be, but not limited to, an electronic storage device, a magnetic storage device, an optical storage device, an electromagnetic storage device, a semiconductor storage device, or any suitable combination of the foregoing. More specific examples of computer-readable storage media (a non-exhaustive list) include: portable computer disks, hard disks, random access memory (RAM), read-only memory (ROM), erasable programmable read-only memory (EPROM or flash memory), static random access memory (SRAM), portable compact disk read-only memory (CD-ROM), digital versatile disk (DVD), memory stick, floppy disk, mechanical encoding devices, punch cards or raised structures in grooves on which instructions are stored, and any suitable combination of the foregoing. The computer-readable storage medium used herein is not to be construed as a transient signal itself, such as radio waves or other freely propagating electromagnetic waves, electromagnetic waves propagated through waveguides or other transmission media (e.g., light pulses through a fiber optic cable), or electrical signals transmitted through wires.

The computer-readable program instructions described herein may be downloaded from a computer-readable storage medium to various computing/processing devices, or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium in the respective computing/processing device.

The computer program instructions for performing the operations of the present disclosure may be assembly instructions, instruction set architecture (ISA) instructions, machine instructions, machine-dependent instructions, microcode, firmware instructions, state setting data, or source code or object code written in any combination of one or more programming languages including object-oriented programming languages such as Smalltalk, C++, or the like and conventional procedural programming languages such as “C” language or similar programming languages. The computer-readable program instructions may be executed entirely on the user's computer, partly on the user's computer, as a stand-alone software package, partly on the user's computer and partly on a remote computer, or entirely on a remote computer or a server. In cases involving a remote computer, the remote computer may be connected to the user's computer through any type of network, including local area network (LAN) or wide area network (WAN), or may be connected to an external computer (e.g., through the Internet using an Internet service provider). In some embodiments, state information of computer-readable program instructions is used to personalize an electronic circuit, such as a programmable logic circuit, a field programmable gate array (FPGA), or a programmable logic array (PLA), the electronic circuit can execute the computer-readable program instructions to implement various aspects of the present disclosure.

Various aspects of the present disclosure are described herein with reference to flowchart and/or block diagrams of the method, apparatus (system) and computer program product according to embodiments of the present disclosure. It will be understood that each block of the flowchart and/or block diagram, and combinations of blocks in the flowchart and/or block diagram, can be implemented by computer-readable program instructions.

These computer-readable program instructions can be provided to a processor of a general-purpose computer, a special-purpose computer, or other programmable data processing devices to produce a machine such that when these instructions are executed by the processor of the computer or other programmable data processing devices, a device is generated that implements the functions/actions specified in one or more blocks in the flowchart and/or block diagram. These computer-readable program instructions may also be stored in a computer-readable storage medium, the instructions enable a computer, a programmable data processing device and/or other devices to operate in a specific manner, so that the computer-readable medium storing the instructions includes a manufactured product, which includes instructions for implementing various aspects of the functions/actions specified in one or more blocks in the flowchart and/or block diagram.

The computer-readable program instructions may also be loaded onto a computer, other programmable data processing devices, or other equipment so that a series of operating steps are performed on the computer, other programmable data processing devices, or other equipment to produce a computer-implemented process, thereby causing the instructions executed on the computer, other programmable data processing devices, or other equipment to implement the functions/actions specified in one or more blocks in the flowchart and/or block diagram.

The flowcharts and block diagrams in the drawings illustrate possible implementation architectures, functions, and operations of systems, methods, and computer program products according to various embodiments of the present disclosure. In this regard, each block in the flowchart or block diagram may represent a module, a program segment or a portion of instructions, which contains one or more executable instructions for implementing the specified logical functions. In some alternative implementations, the functions noted in the blocks may occur out of the order noted in the drawings. For example, two consecutive blocks may actually be executed substantially in parallel, or they may sometimes be executed in the reverse order, depending on the functions involved. It should also be noted that each block in the flowcharts or block diagrams, and combinations of blocks in the block diagrams and/or flowcharts, can be implemented by a dedicated hardware-based system that performs the specified function or action, or can be implemented by a combination of dedicated hardware and computer instructions. It is well known to those skilled in the art that implementation by hardware, implementation by software, and implementation by a combination of software and hardware are all equivalent.

Various embodiments of the present disclosure have been described above, and the above description is exemplary, not exhaustive, and is not limited to the disclosed embodiments. Many modifications and variations will be apparent to those of ordinary skill in the art without departing from the scope and spirit of the described embodiments. The terms used herein are selected to best explain the principles of the embodiments, or practical applications technical improvements in the marketplace, or to enable other ordinary technicians in the art to understand the embodiments disclosed herein. The scope of the present disclosure is defined by the appended claims.

1. A display control method for an augmented reality head-mounted device, comprising:
receiving a first enable instruction for enabling a first application in a running process of a 3D desktop environment;
creating a first canvas and a first virtual screen in the 3D desktop environment in response to the first enable instruction when the first application is a 2D application;
running the first application on the first virtual screen; and
acquiring texture information from the first virtual screen, and rendering the texture information acquired from the first virtual screen onto the first canvas.

2. The method of claim 1, further comprising:
detecting whether a 3D engine tag is contained in a global configuration file of the first application when the first enable instruction is received; if not, determining the first application as the 2D application.

3. The method of claim 1, further comprising:
acquiring attribute information of the first application from an application menu provided by the 3D desktop environment when the first enable instruction is received, and determining whether the first application is the 2D application according to the attribute information of the first application.

4. The method of claim 1, further comprising:
exiting the 3D desktop environment in response to the first enable instruction when the first application is a 3D application, and
starting the first application after the 3D desktop environment is exited.

5. The method of claim 4, further comprising: after the starting the first application,
receiving a first control instruction to exit the first application; and
exiting the first application in response to the first control instruction, and running the 3D desktop environment.

6. The method of claim 1, further comprising:
receiving an operation instruction from a user in a process of running the first application;
acquiring a coordinate value of a collision point in the first canvas when a 3D ray mapped by the operation instruction collides with the first canvas;
determining a target pixel on the first virtual screen corresponding to the collision point according to the coordinate value of the collision point in the first canvas; and
controlling the first application to trigger a touch event corresponding to the target pixel.

7. The method of claim 1, further comprising:
receiving a second enable instruction for enabling a second application in the running process of the 3D desktop environment;
creating a second canvas and a second virtual screen in the 3D desktop environment in response to the second enable instruction when the second application is the 2D application, wherein the first canvas and the second canvas are located at different positions in the 3D desktop environment;
running the second application on the second virtual screen; and
acquiring texture information from the second virtual screen, and rendering the texture information acquired from the second virtual screen onto the second canvas.

8. Display control apparatus for an augmented reality head-mounted device, comprising:
a receiving module configured to receive a first enable instruction for enabling a first application in a running process of a 3D desktop environment;
a creation module configured to create a first canvas and a first virtual screen in the 3D desktop environment in response to the first enable instruction when the first application is a 2D application;
a running module configured to run the first application on the first virtual screen; and
a rendering module configured to acquire texture information from the first virtual screen and render the texture information acquired from the first virtual screen onto the first canvas.

9. An augmented reality head-mounted device, comprising:
a memory configured to store executable computer instructions; and
a processor configured to execute the display control method of claim 1 under control of the executable computer instructions.

10. A non-transitory computer-readable storage medium, on which computer instructions are stored, wherein the computer instructions, when executed by a processor, executes the display control method of claim 1.
